(19) United States
(12) Patent Application Publication
(10) Pub. No.: US 2019/0235128 A1
(43) Pub. Date: Aug. 1, 2019

(54) DETERMINATION OF VIRTUAL PROCESS PARAMETERS

(71) Applicant: GE Inspection Technologies, LP, Lewistown, PA (US)

(72) Inventors: Mahadevan Balasubramaniam, Mechanicville, NY (US); Arun Karthi Subramaniyan, Danville, CA (US); Fabio Nonato de Paula, Livermore, CA (US); Shyam Sivaramakrishnan, Niskayuna, NY (US); Shourya Otta, San Ramon, CA (US); Chennan Li, Fremont, CA (US)

(21) Appl. No.: 16/258,201

(22) Filed: Jan. 25, 2019

Related U.S. Application Data
(60) Provisional application No. 62/622,694, filed on Jan. 26, 2018.

(51) Int. Cl. G01V 99/00; G06F 17/50; G06N 7/00; E21B 47/06

(52) U.S. Cl. CPC G01V 99/005; G06F 17/5018; G06F 2217/16; E21B 47/06; G06N 7/00

(57) ABSTRACT

A method can include generating a first predictive model associated with a first well of a plurality of wells in a cluster, the first well configured to produce a first fluid output and a second well of the plurality of wells configured to produce a second fluid output, the first and the second fluid outputs flow to a cluster manifold via a system of pipelines in the cluster. The method includes receiving data characterizing one or more pressure measurements in the cluster and indicative of one or more pressure values associated with the first fluid output, and the second fluid output. The method can further include recalibrating the first predictive model based on the one or more of the pressure measurements and historical data associated with the first well. Related apparatus, systems, articles, and techniques are also described.

### RELATED APPLICATION

This application claims priority under 35 U.S.C. § 119(e) to U.S. Provisional Patent Application No. 62/622,694 filed on Jan. 26, 2018, the entire contents of which are hereby expressly incorporated by reference herein.

### BACKGROUND

Values of process variables at a process plant (e.g., oil flow at an oil rig) can be tracked (e.g., at regular interval) to monitor the operation of the plant. Observing the process variables can allow an operator to ensure desirable operation of the plant. The process values can be measured, for example, by sensors (e.g., fluid flow meters, pressure gauges, thermocouples, accelerometers) located at the process plant. However, it may not be possible to detect values of all the desirable processes and/or values of a process at multiple locations in the process plant. This can be due to prohibitive cost of installing multiple sensors. Additionally, sensors that can detect certain processes (e.g., multi-phase fluid flow) can be expensive.

Numerical simulation based on regression models can be used to predict process values that cannot be directly measured. The numerical simulations can use process values measured by one or more sensors added to the process plant as outputs of the regression models. Such techniques may not be accurate as they do not model the actual processes at the plant and can be prone to over fitting. Additionally, these regression-based methods may require a large set of additional data for building the regression model.

### SUMMARY

In general, apparatus, systems, methods and articles of manufacture for determination of virtual process parameters are provided.

In one aspect, a method can include generating a first predictive model associated with a first well of a plurality of wells in a cluster. The first well can be configured to produce a first fluid output and a second well of the plurality of wells can be configured to produce a second fluid output. The first and the second fluid outputs flow to a cluster manifold via a system of pipelines in the cluster. The method can also include receiving data characterizing one or more pressure measurements in the cluster. The one or more pressure measurements can be indicative of one or more pressure values associated with the first fluid output, and the second fluid output. The method can further include recalibrating the first predictive model based on the one or more of the pressure measurements and historical data associated with the first well. The method can also include providing a first flow rate of the first fluid output calculated by the recalibrated first predicted model.

One or more of the following features can be included in any feasible combination.

In one aspect, the method can further include receiving data characterizing well head pressure detected at the first well and calculating the first flow rate based on the data characterizing well head pressure. In another aspect, the recalibration of the first predictive model can be repeated when a difference between the calculated flow rate of the first fluid output and a detected flow rate of the first fluid output exceeds a predetermined threshold value.

In one aspect, the method can further include generating a manifold predictive model based on the first predictive model associated with the first well, a second predictive model associated with the second well, and a pipeline characteristic model associated with the system of pipelines. The pipeline characteristic model can be based on a change in pressure of a fluid and/or change in phase of the fluid flowing along a segment of the system of pipeline. The fluid can include the first fluid output and the second fluid output. The manifold predictive model can include a thermodynamic model based on inenthalpic mixing of the first fluid output and the second fluid output. The cluster manifold can include a separator configured to separate a mixture of first fluid output and second fluid output into an oil output and a water output. The manifold predictive model can be configured to calculate a second flow rate of the oil output and a third flow rate of the water output.

In one aspect, the first predictive model can be generated based on historical data indicative of one of more of well head pressure values, flow rate values and ratio between oil and gas in the first fluid output detected at the first well. In another aspect, the method can further include varying one or more of an operating parameter of a pump at the first well and/or a valve operating value of a first well head at the first well based on the calculated first flow rate. In yet another aspect, the first fluid output can include one or more of oil, gas and water produced by the first well.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

These and other capabilities of the disclosed subject matter will be more fully understood after a review of the following figures, detailed description, and claims.

### BRIEF DESCRIPTION OF THE FIGURES

These and other features will be more readily understood from the following detailed description taken in conjunction with the accompanying drawings, in which:

FIG. 1 is a flowchart illustrating an exemplary method of determining virtual measurement value;

FIG. 2 is a schematic figure illustrating an exemplary virtual measurement system;

FIG. 3 is a plot illustrating a distribution of virtual process parameter values and variability data associated with the process;

FIG. 4 is a schematic illustration of an oil field with multiple oil well clusters; and

FIG. 5 is a flow chart of an exemplary method of detecting virtual process parameters in an oil field

### DETAILED DESCRIPTION

Simulations can be used to estimate variables of processes that may not be directly measured by sensors, referred to as virtual measurement. However, such simulations may be slow, inaccurate, and/or may not capture the operating principles of the process. Accordingly, systems and corresponding methods for improved virtual measurement are provided. As discussed in detail below, improved virtual measurements can be obtained using an iterative, cloud-based, process flow model. As an example, a process flow model can be used to simulate a process (e.g., based on first principles) and calculate an unobserved process value from a set of observed process values (e.g., detected by a sensor). Multiple process flow models simulations can be iteratively performed on instances of a cloud to generate virtual measurement values of the process. In one aspect, a set of virtual measurement values can be determined faster due parallelization of the simulation. In another aspect, as compared to existing simulation approaches (e.g., those based upon regression models), more accurate virtual measurement values of a process can be achieved by use of an iterative process based upon variability of data associated with the process.

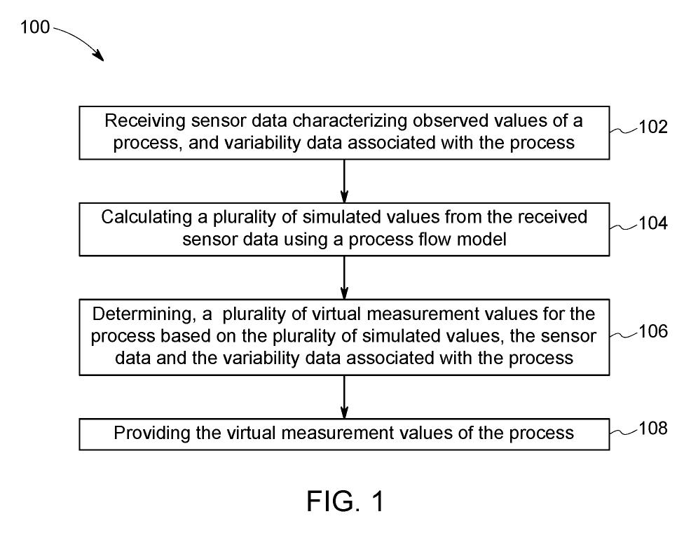

FIG. 1 is a flowchart illustrating one exemplary embodiment of a method 100 for determining virtual measurement values. As shown, the method includes operations 102, 104, 106, and 108. In operation 102, a computing device can receive sensor data that includes observed values of a process, and/or variability data associated with the process. In certain embodiments, the sensor data can be detected by sensors (e.g., flow meters) placed at a process site (e.g., an oil well, refinery, chemical plant). Variability data can include, but are not limited to, historical measurement data of the process site (e.g., previously detected sensor data), detection error associated with the sensors, predetermined calibration data of the process, design data, and the like. In certain embodiments, the computing device can receive the sensor data and/or the variability data from a memory device (e.g., a database or other data storage device in a cloud). In other embodiments, at least the sensor data can be received by the computing device from the sensor.

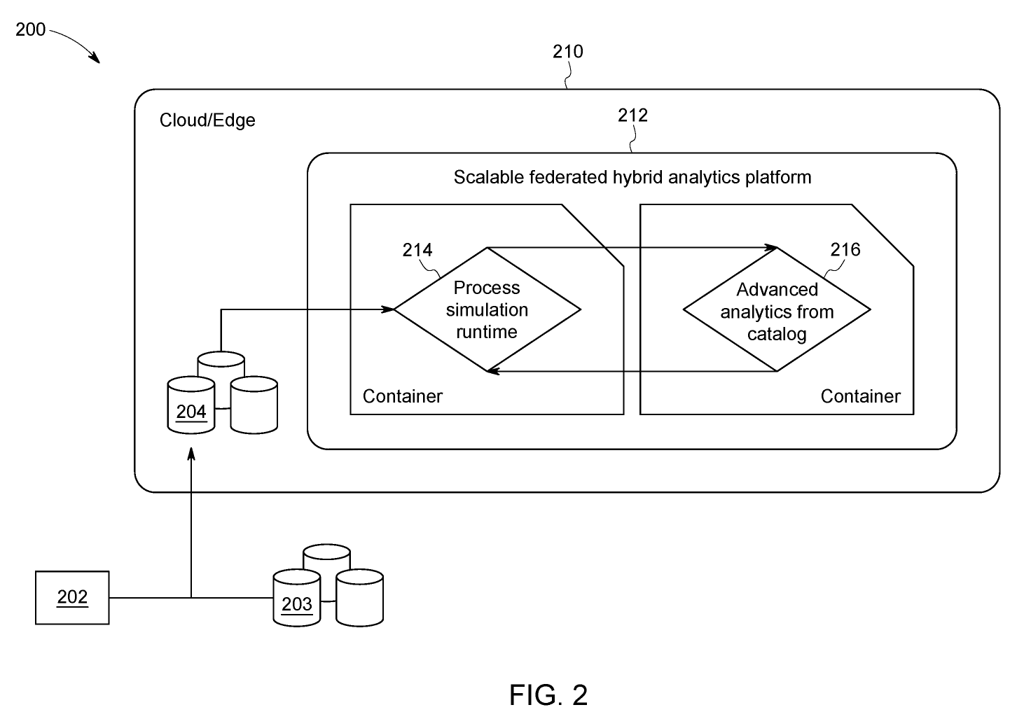

FIG. 2 is a schematic diagram illustrating one exemplary embodiment of a virtual measurement system 200. Sensor data can be detected from sensors located at a process site 202 (e.g., a plant) and the sensor data can be stored in a memory 204 (e.g., a database) located in a cloud (or “edge”) 210. In one implementation, sensor data collected at process site 202 can be stored in an external memory 203. Sensor data can be transferred from the external memory 203 to the memory 204 in the cloud. The cloud 210 can include a computing device (not shown) that configured to execute an instance 212. The instance 212 can be further configured to calculate virtual measurement values (e.g., by using a federated hybrid analytics platform). The instance 212 can include a simulation runtime 214 that can execute a process flow model, discussed below. The instance 212 can also include an analytic runtime 216 that can calculate virtual measurement values by iteratively executing the simulation runtime 214. In one implementation, the analytic runtime 216 can iteratively execute the simulation runtime 214 at other instances in the cloud 210.

Returning to FIG. 1, in operation 104 a plurality of simulated values can be calculated from the received sensor data using the process flow model. The process flow model can be executed (e.g., simultaneously) on multiple instances (e.g., nodes) of a cloud. In one implementation, an instance (e.g., instance 212) can receive a first observed value of the sensor data and the instance 212 can use this first observed value as an input to the process flow model to calculate a first simulated value. Multiple instances on the cloud can calculate simulated values for different observed values in the sensor data. In one implementation, multiple instances can perform this calculation in parallel (e.g., simultaneously).

In operation 106, a plurality of virtual measurements values for the process can be determined. As an example, one or more simulated values (e.g., calculated at 104) can be selected through an uncertainty quantification method (e.g., a Monte Carlo technique). In the uncertainty quantification method, samples of the sensor data collected in 102 (which can represent the variability of the sample data) are provided as inputs to the process flow model (e.g., input at step 104) for parallel execution in the cloud environment. Subsequently, observed values (e.g., observed values corresponding to each of the selected simulated value) can be determined. An iterative estimation process (e.g., a Bayesian estimation process) can use the observed values, the multitude of simulated value and the corresponding variability data (e.g., received at step 102) of the process to calculate a virtual measurement value. The iterative estimation process can update the variability of the unobserved variables (e.g., virtual measurements) by drawing samples closer to the most-likely virtual measurement at each step of the iterative process, while taking into account the conditional probability of the unobserved variables given the corresponding observed values. Operation 106 can be repeated for one or more of the selected simulated value to determine a distribution of virtual measurement values.

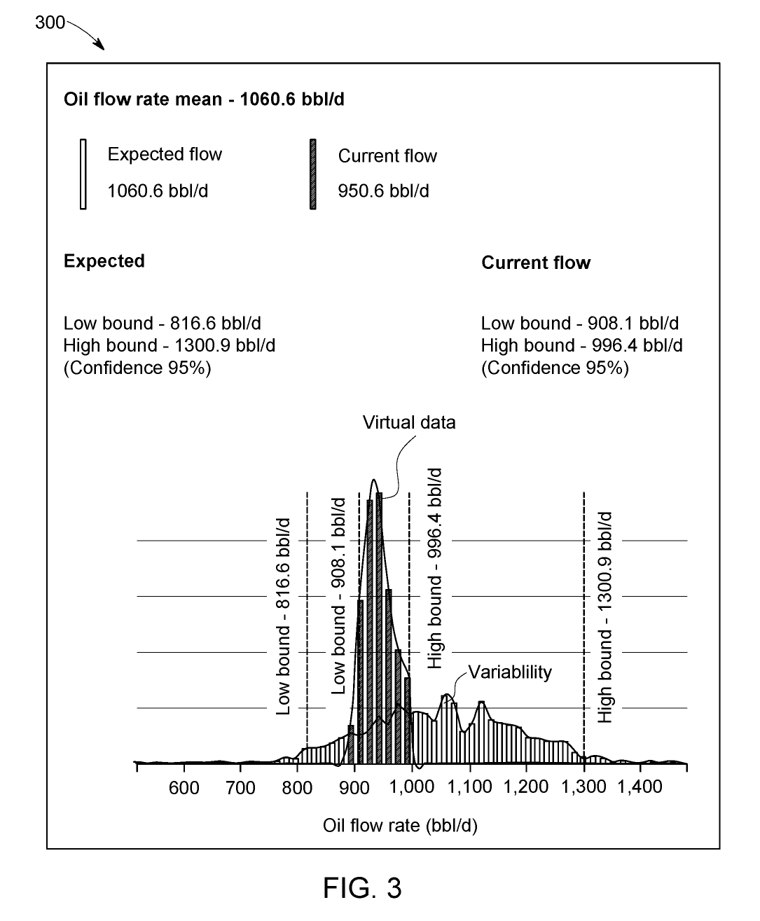

FIG. 3 is a plot 300 illustrating exemplary embodiments of distribution of virtual process parameters (e.g., virtual oil flow) values and variability data associated with the virtual process parameter. The variability data (dark shading) is indicative of a range of expected parameter values. This can be based on, for example, historical average of parameters values.

Returning to FIG. 1, in operation 108, virtual measurement values calculated at 106 are provided. For example, the virtual measurement values can be saved in a database and/or presented to an operator. In another implementation, the virtual measurement values can be used in an automated system to determine desirable (e.g., optimal) operating parameters of the process, and change the operating parameters of the process based on this determination.

The virtual process parameters can be calculated outputs of various oil and gas industrial machines in an oil field. The oil field can include multiple clusters of oil wells. The output of the oil wells (e.g., oil, gas, water or a mixture thereof) can be connected via a system of pipelines. For example, output of oil wells in a cluster can be transferred to a cluster manifold where the various outputs can be combined and/or separated into oil, gas and water. Sensors (e.g., pressure sensors, flow sensors, etc.) can be deployed at various locations in the oil fields to detect pressure and flow of output from an oil field (e.g., oil output). These sensors may be old and may not provide accurate measurement of oil output. This can result in erroneous determination of oil production from an oil field and can lead to loss in revenue. Therefore, it is desirable to develop a predictive model that can improve the measurement accuracy of oil production (e.g., by calculation of virtual process parameters).

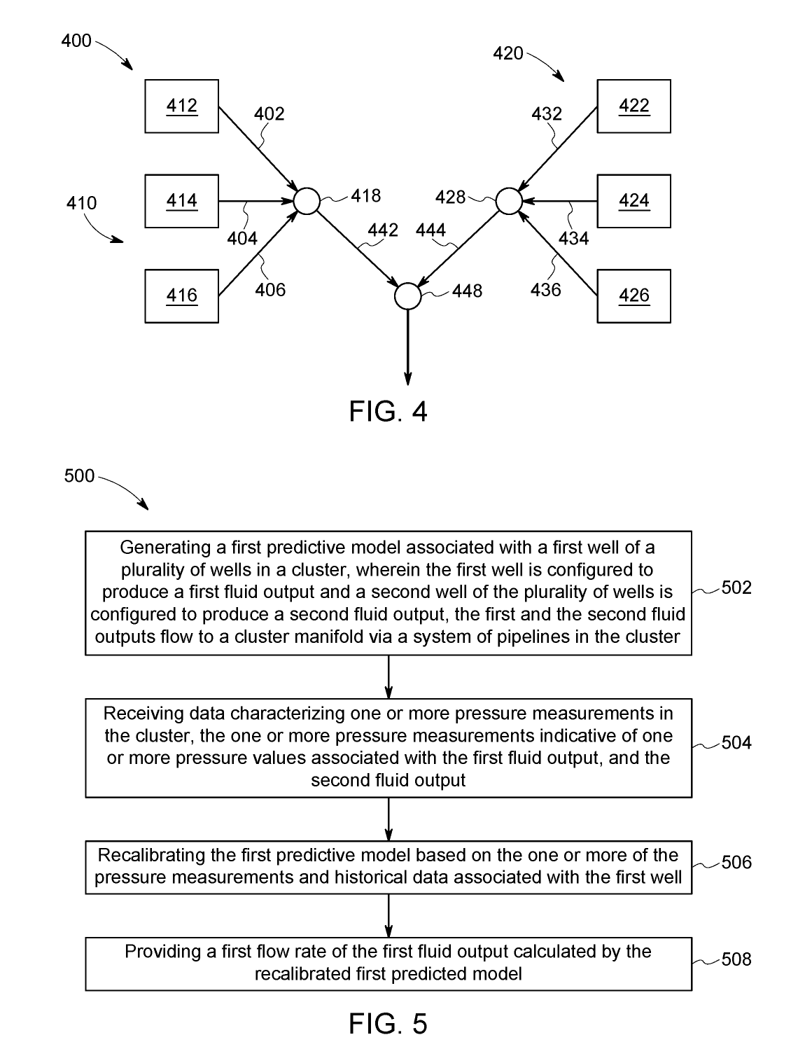

FIG. 4 is a schematic illustration of an oil field 400. The oil field 400 can include oil clusters 410 and 420 comprising multiple oil wells. The oil cluster 410 can include multiple oil wells 412, 414, 416, and the output of the oil wells (e.g., a multiphase fluid including oil, gas and water) can be transferred to a cluster manifold 418 via pipes 402, 404 and 406. The oil cluster 420 can include multiple oil wells 422, 424, 426, and the output of the oil wells (e.g., a multiphase fluid including oil, gas and water) can be transferred to a cluster manifold 428 via pipes 432, 434 and 436. At the cluster manifold 418, outputs of the oil wells 412, 414, 416 can be combined. The combined outputs from clusters 410 and 420 can be transferred to a third manifold 448 via pipes 442 and 444, respectively. Output from the third manifold 448 can be transferred to downstream facilities (e.g. gas processing facilities, oil facilities, etc.). The manifolds 418, 428 and 448 can include a separator that can separate various components of the multiphase fluid (e.g., oil, gas and water).

During the initial phase of production, oil wells can be naturally flowing and fluid (e.g., oil) oozes out of the well due to pressure at the reservoir that can lift the oil naturally to the surface. As the oil well ages, the reservoir pressure can decrease and an artificial lift mechanism (e.g., Electric submersible pumps, Gas Lift, Gas Injection, Rod Lift Pumps etc.) needs to be used to extract oil. For example, the wells 412-416 and 422-426 can include pumps to extract oil. The wells can also include flow sensors to measure the fluid output of the well, pressure sensors (e.g., to measure well head pressure) and sensors to detect the composition of the fluid output. These sensors can be located at one or more locations in the pipes (e.g., 402-406, 432-436, etc.) and manifolds 418, 428 and 448.

It can be desirable to maintain a continuous production of oil (e.g., a predetermined flow of output 448) and prevent unplanned shutdowns. Replacing a sensor in the oil field that is producing inaccurate measurement can lead to downtime which is not be desirable. However, predictive models can be developed for the various sensors that can calculate virtual parameters associated with the sensors. In some implementations, virtual parameters can be calculated at a location where no sensor is present (e.g., virtual pressure detection at a location where no pressure sensor is present). The predictive models can be calibrated based on various sensor measurements in the oil field, physical model of sensors, physical model of oil wells, physical model of pipes, etc. Because the oil wells in the oil field are interconnected via a network of pipes, sensor measurement at various locations in the oil fields can be used to calibrate a predictive model (e.g., predictive model for a sensor measurement or a process) in the oil field (e.g., a predictive model of a sensor remote from the measurement location).

FIG. 5 is a flow chart of an exemplary method of calculating virtual process parameters in an oil field. At 502, a first predictive model associated with a first well (e.g., well 412) of a plurality of wells in a cluster of oil wells (e.g., cluster 410) can be generated. The predictive model can calculate the flow rate of fluid produced by the first well based on well head pressure at the first well. The predictive model can be generated based on historical data associated with the first well. In some implementations, the historical data can include measurement of well head pressure, flow rates, ratio between oil and gas in the fluid that were made at the first well. The historical data can be saved in a database (or on a cloud) and can be retrieved (e.g., by an analytic system).

At 504, data characterizing one or more pressure measurements in the cluster can be received. Various pressure sensors in the oil field can perform pressure measurements and can transmit a measurement signal (e.g., to the analytic system). In some implementations, the pressure sensors can be configured to detect well head pressures at the various wells in the oil field, pressures at various locations in the pipes in the oil fields, and the like. Based on the pressure measurements (or flow measurements), the predictive model of the first oil well can be calibrated. For example, if the pressure detected at manifold 418 is much larger (or smaller) than expected pressure (e.g., based on pressure measurements at the oil well 412-416, pipes 402-406, etc.; virtual flow rate from predictive models associated with the oil wells 412-418, etc.), the analytic system can determine that one or more of the flow rate predictive models at oil wells 412-418 need to be calibrated. In some implementations, the analytic system can use the pressure detected at the manifold 418 as a constraint in the recalibration of the one or more flow rate predictive models.

At 506, the flow rate predictive model of the oil well (e.g., well 412) can be recalibrated based on the pressure measurements and historical data associated with the first well. In some implementations, recalibration of the predictive model can be achieved by an optimization algorithm that can update one or more coefficients of a characteristic equation of the first well. The recalibrated predictive model can be used to calculate revised fluid flow rates at the first well (e.g., based on well head pressure at the first well). In some implementations, the recalibration process can be performed (or repeated) when a difference between the flow rate calculated by the predictive model of the first well and the flow rate detected by a flow rate sensor at the first well exceeds a predetermined threshold value.

At 508, flow rate calculated by the predictive model (“virtual flow rate”) can be provided. For example, the virtual flow rate can be displayed on a graphical user interface display space and/or stored in a database. In some implementations, the analytic system can vary an operating parameter of a pump at the first well and/or a valve operating value of a well head at the first well based on the calculated virtual first flow rate. This can be done for example, to maintain a desirable flow rate in the oil field (e.g., flow rate of oil exiting manifold 448).

In some implementations, a manifold predictive model can be generated (e.g., for manifolds 418, 428, 448, etc.). The manifold predictive model can be generated based on predictive models of oil wells and pipes that are upstream from the manifold. For example, manifold predictive model for manifold 418 can be based on models associated with wells 412-416 and pipes 402-406. The manifold predictive model can also be based on one or more sensor measurements taken upstream from the manifold (e.g., change in pressure of a fluid and/or change in phase of the fluid flowing along a segment of a pipeline upstream from the manifold). In some implementations, the manifold predictive model can be based on (or calibrated) sensor measurements downstream from the manifold. In some implementations, the manifold predictive model can include a thermodynamic model based on inenthalpic mixing of the fluid outputs from the various wells upstream from the manifold. In some implementations, a manifold can include a separator that can separate fluid arriving at the manifold from the wells upstream from the manifold. For example, the separator can separate oil, gas and water from the multiphase fluid arriving at the manifold. In some implementations, the manifold predictive model can calculate the flow rates of oil, gas, and water that are obtained from the above-mentioned separation.

Exemplary technical effects of the methods, systems, and devices described herein include, by way of non-limiting example, expediting the calculation of virtual measurement values, for example, due to parallelization of the simulation. Further, applying an iterative algorithm to the simulation of process flow algorithm can result in accurate and robust determination of virtual measurement values.

Certain exemplary embodiments are described herein to provide an overall understanding of the principles of the structure, function, manufacture, and use of the systems, devices, and methods disclosed herein. One or more examples of these embodiments are illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

Other embodiments are within the scope and spirit of the disclosed subject matter. One or more examples of these embodiments are illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

Approximating language, as used herein throughout the specification and claims, may be applied to modify any quantitative representation that could permissibly vary without resulting in a change in the basic function to which it is related. Accordingly, a value modified by a term or terms, such as “about” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

What is claimed is:

1. A method comprising:
generating a first predictive model associated with a first well of a plurality of wells in a cluster, wherein the first well is configured to produce a first fluid output and a second well of the plurality of wells is configured to produce a second fluid output, the first and the second fluid outputs flow to a cluster manifold via a system of pipelines in the cluster;
receiving data characterizing one or more pressure measurements in the cluster, the one or more pressure measurements indicative of one or more pressure values associated with the first fluid output, and the second fluid output;
recalibrating the first predictive model based on the one or more of the pressure measurements and historical data associated with the first well; and
providing a first flow rate of the first fluid output calculated by the recalibrated first predicted model.

2. The method of claim 1, further comprising receiving data characterizing well head pressure detected at the first well and calculating the first flow rate based on the data characterizing well head pressure.

3. The method of claim 2, wherein the recalibration of the first predictive model is repeated when a difference between the calculated flow rate of the first fluid output and a detected flow rate of the first fluid output exceeds a predetermined threshold value.

4. The method of claim 1, further comprising generating a manifold predictive model based on the first predictive model associated with the first well, a second predictive model associated with the second well, and a pipeline characteristic model associated with the system of pipelines.

5. The method of claim 4, wherein the pipeline characteristic model is based on a change in pressure of a fluid and/or change in phase of the fluid flowing along a segment of the system of pipeline.

6. The method of claim 5, wherein the fluid includes the first fluid output and the second fluid output.

7. The method of claim 4, wherein the manifold predictive model includes a thermodynamic model based on inenthalpic mixing of the first fluid output and the second fluid output.

8. The method of claim 4, wherein the cluster manifold includes a separator configured to separate a mixture of first fluid output and second fluid output into an oil output and a water output.

9. The method of claim 8, wherein the manifold predictive model is configured to calculate a second flow rate of the oil output and a third flow rate of the water output.

10. The method of claim 1, wherein the first predictive model is generated based on historical data indicative of one of more of well head pressure values, flow rate values and ratio between oil and gas in the first fluid output detected at the first well.

11. The method of claim 1, further comprising varying one or more of an operating parameter of a pump at the first well and/or a valve operating value of a first well head at the first well based on the calculated first flow rate.

12. The method of claim 1, wherein the first fluid output includes one or more of oil, gas and water produced by the first well.

13. A system comprising:
at least one data processor;
memory coupled to the at least one data processor, the memory storing instructions to cause the at least one data processor to perform operations comprising:
generating a first predictive model associated with a first well of a plurality of wells in a cluster, wherein the first well is configured to produce a first fluid output and a second well of the plurality of wells is configured to produce a second fluid output, the first and the second fluid outputs flow to a cluster manifold via a system of pipelines in the cluster;
receiving data characterizing one or more pressure measurements in the cluster, the one or more pressure measurements indicative of one or more pressure values associated with the first fluid output, and the second fluid output;
recalibrating the first predictive model based on the one or more of the pressure measurements and historical data associated with the first well; and
providing a first flow rate of the first fluid output calculated by the recalibrated first predicted model.

14. The system of claim 13, wherein the operations further comprising receiving data characterizing well head pressure detected at the first well and calculating the first flow rate based on the data characterizing well head pressure.

15. The system of claim 14, wherein the recalibration of the first predictive model is repeated when a difference between the calculated flow rate of the first fluid output and a detected flow rate of the first fluid output exceeds a predetermined threshold value.

16. The system of claim 13, wherein the operations further comprising generating a manifold predictive model based on the first predictive model associated with the first well, a second predictive model associated with the second well, and a pipeline characteristic model associated with the system of pipelines.

17. The system of claim 16, wherein the pipeline characteristic model is based on a change in pressure of a fluid and/or change in phase of the fluid flowing along a segment of the system of pipeline.

18. The system of claim 17, wherein the fluid includes the first fluid output and the second fluid output.

19. The system of claim 16, wherein the manifold predictive model includes a thermodynamic model based on inenthalpic mixing of the first fluid output and the second fluid output.

20. The system of claim 16, wherein the cluster manifold includes a separator configured to separate a mixture of first fluid output and second fluid output into an oil output and a water output.
